(19) United States
(12) Patent Application Publication
(10) Pub. No.: US 2017/0153013 A1
(43) Pub. Date: Jun. 1, 2017

(54) DEVICE WHICH CAN BE FASTENED TO A CEILING FOR HOLDING AN ELECTRICAL CONSUMER, FOR EXAMPLE, LUMINAIRE OR DISPLAY

(71) Applicant: Ahmet BALKAYA, Wuppertal (DE)

(72) Inventor: Ahmet BALKAYA, Wuppertal (DE)

(21) Appl. No.: 15/321,761

(22) PCT Filed: Jun. 27, 2015
(86) PCT No.: PCT/DE2015/000330

§ 371 Date: Dec. 23, 2016

(30) Foreign Application Priority Data
Jun. 30, 2014 (DE) 10 2014 109 128.0

(51) Int. Cl. F21V 21/28; F16M 13/02; F21V 21/03; F21V 21/15; F21S 8/04; F21V 23/00

(52) U.S. Cl. CPC F21V 21/28; F21S 8/043; F21V 23/002; F21V 21/03; F21V 21/15; F16M 13/027

(57) ABSTRACT

The invention relates to a ceiling light for attaching to a room ceiling and positioning a light (2) or other electrical device at any point within a defined circular area on the room ceiling. To this end, the light (2) is attached to a roller carriage (3) displaceably inserted in a hollow profile (4) rotatable about the center axis thereof. The hollow profile (4) is attached to the room ceiling by means of a center axial bearing (10) in which a rotatable power transmission system is integrated and is supported against the room ceiling at both ends by support rollers (19). Tilting motions are thereby prevented. The power supply is provided by means of the centered power source typical of room ceilings, in that the power is transmitted by means of the rotatable power transmission system to a power cable (14) routed within the displacing device, fed to the roller carriage (3) by means of said cable, and connected to the light there.

The invention relates to a device for mounting an object, particularly an electrical consumer, such as a light or a display having a ceiling mounting element for attaching to a room ceiling, holding an elongated support body extending in a horizontal plane and rotatable about the vertical axis running through the ceiling mounting element, and forming two support arms facing away from the ceiling mounting element, on which support body a mounting element displaceable in the direction of extent of the support body, on which the consumer can be attached, the electrical supply line thereof running through the support body to the ceiling mounting element, and a support element for supporting the supporting body on the ceiling.

A device for placing a light at different positions of the room ceiling is known from DE 20018062 U1. The main element thereof is a support rod pivotable about a center of rotation. A division of the support rod into a supporting arm and a bracing arm is defined therein. The light can be displaced within a partial region of the supporting arm. The number of potential rotations of the support rod is limited to a maximum of one rotation, as no solution is provided for preventing the power cable from winding up and tearing when rotated repeatedly. The support rod must therefore always be rotated by 180° in order to be able to place the light on the opposite side of the center of rotation.

A slider is provided on the support rod. Sliding the same exerts undesired forces on the central mounting point on which the entire device is suspended. Repositioning the light is indeed possible by means of said design, but it is only intended for occasional changes in position and the components are accordingly designed for only occasional changes in position.

A device described in CH 168867 A can also be used for repositioning a light. Tubes inserted into each other at right angles and having counterweights are used therein for adjusting the light vertically and horizontally. Therefore, even when lighter materials are used, a relatively high integral weight of the entire design can be expected. Shifting the tubes involves friction, loading the attachment point of the device on the room ceiling with additional forces. For safety reasons, the central attachment to the room ceiling would therefore have to be made stronger than is typical for ceiling lights.

An adjustable ceiling light mounting element is known from DE 92 17 204 U1. A support rod is thereby continuously displaceable relative to a ceiling mounting element, is supported at one end by the ceiling, and at the other end supports a light displaceable thereon.

A supporting arm for rotatably attaching to a ceiling attachment is known from DE 668 975 A and 89 13 817 U1, comprising a hollow space in which a slide can be displaced on which a light is suspended.

U.S. Pat. No. 2,114,664 describes a supporting arm attached to an annular ceiling attachment comprising a hollow space in which a slide is displaceable, on which a light is suspended.

The material and labor required for installation on the room ceiling is thus increased because the device can be implemented on by experienced private persons or technical experts. For the case that said device is installed as a retrofit, all existing attachment points must be reinforced with larger or an increased number of holes, anchors, and screws. This would be associated in turn with additional costs for private persons or seniors without technical experience. The light in said device is attached at the tip of the supporting arm, where the fixed power supply is present.

The supporting arm in the form of a tube is pushed back and forth in the horizontal direction through a close-fit horizontal hole in a vertical tube attached to the ceiling, thereby changing the position of the light. The support bar must be rotated by 180° in order to be able to place the light on the opposite side of the center of rotation. Here again the supporting arm cannot be rotated an arbitrary number of times, because there is no solution to prevent the power cable from winding up and tearing. Accessibility to the room is also hindered when the supporting arm is lowered, because said is then horizontal in the room. Said device is also static in concept, and the components thereof are designed only for occasional changes in position. Said design also requires a great deal of material and is unaesthetic. The object of the invention is to disclose a device for mounting an object, particularly an electrical consumer, such as a light or a display, by means of which the object can be disposed at nearly any arbitrary point in the room.

The object is achieved by the invention disclosed in claim 1. The subclaims represent advantageous refinements of the invention.

It is first and substantially proposed that one support element in the form of a support roller is provided on each of the supporting arms, by means of which the supporting arm can be supported against the room ceiling. The mounting element can further be displaced along the entire length of the support body. The mounting element is an element for displacing in the support body, holding the object, such as a light or a display, by means of a high-tensile rope or cable, for example. The length of the rope or cable is adjustable and defines the vertical position of the object in the room. The position of the mounting element on the support body and the angular position of the support body define the horizontal position of the object. In a particularly preferred embodiment, the invention forms a ceiling light by means of which a luminous element can be positioned at nearly any arbitrary location in a room, wherein the position of the luminous element can be changed by simple means. It is further proposed that the support body can be rotated by any arbitrary angle of rotation about the vertical axis without any limiting stop. A light can thus be displaced in both the horizontal and vertical direction in the switched-on state. In a horizontal plane, the light can be continuously displaced along a circular path and thereby reach nearly any arbitrary point in the room. Due to the support elements disposed on each of the two supporting arms, it is further possible to position in the room any arbitrary suspended light available on the market, regardless of weight or shape. In the same manner, other electrical or electronic devices, that is, electrical consumers, can be positioned in the room. In the same manner it is possible to attached non-electrical objects to the support body. A cable is then not required for attaching to the mounting element, but rather a chain or a rope or a bar on which the object is suspended can be used. In an automated variant, remote-controlled drives and programmable controllers can be used to perform arbitrary motion sequences. The ceiling mounting element can comprise an axial bearing having electrical contacts disposed coaxially to the vertical axis. Said contacts can preferably be sliding contacts by means of which an electrical power connection can be produced between a power connection at the room ceiling and the support body. A cable can run in the support body, routed there as a loop, and by means of which the mounting element displaceable in the support body can be supplied with electrical power. The mounting element can be displaceable in a hollow of the support body implemented as a hollow profile, particularly a C-profile. The mounting element can be a roller carriage comprising running rollers running on two running flanks flanking a slit extending in the direction of extent of the support body. In an automated variant of the invention, the roller carriage can be driven by a motor, particularly an electric motor. The ceiling mounting element can comprise an electric motor by means of which the support body can be rotationally driven in any arbitrary direction of rotation, wherein the rotation takes place without any limiting stop. In the automated version, the roller carriage can also comprise a device for driving a motor for shortening or lengthening the rope or cable on which the object is suspended. To this end, a winding device or a roller arrangement can be provided, for example. The support elements can be implemented as support rollers, each rotationally supported about an axis extending in the direction of extent of the support body. The support rollers can each be disposed at the ends of the support body.

At least one support roller should be spring-loaded in the vertical direction. One vertically spring-loaded support roller is preferably present at each end of the support body. The vertical adjustability of the object, that is, particularly of the luminous element, can be provided by means of a spring balancer. For example, a store of rope or cable can be present in the mounting element, preferably in the roller carriage, and wound about a spool, for example. In the automated version, a controller is provided, by means of which the drive motors mentioned above for rotating the support body, for linearly displacing the mounting element, or for vertically displacing the object can be actuated. The controller can be present within the support body. In a teaching procedure or a programming procedure, end positions of the object in the room can be defined. Said positions can then be approached under programmed control. The object can thus be controlled by the program to travel to various end positions along defined trajectories.

A particularly preferred embodiment of the device is a ceiling light.

The benefit of the invention for the user is that lights available commercially, which vary in number of bulbs used, model, type of installation, location, technical illumination properties, mechanical properties, size, shape, and design, can be partially replaced. The invention can thus save the user the costs of purchase and energy and provide both functional technical value and a new aesthetic value not previously available in this form.

The established types of lights provide light sources that, once positioned, typically do not ever or only occasionally to seldom change position, because they are not designed for continuous changes in position. Therefore the occupants of a residence typically adapt to the static lighting conditions. Until now there has been no low-cost lighting solution wherein the light adapts dynamically to the peoples' light requirements, which change many times each day. The motion device according to the invention now provides a technical solution by means of which a light source, typically in the form of a ceiling light, can be displaced to any arbitrary position in the room at any time and arbitrarily often.

Considering the need to save raw materials and energy resources, including electricity, it is important to reduce energy consumption for lighting purposes, as these are a substantial portion of overall consumption. In order to reduce costs for the purchase and operation of lights for the user, it is necessary to reduce the total number of lights and therefore of light bulbs used in a residence. In addition to saving the costs of purchase and of energy, the material and effort required for drilling attachment holes in the ceiling and walls and the installation of electrical lines can thus be reduced.

The device according to the invention provides the ability to optimally utilize the existing electrical connection and mounting sites in residential rooms, typically centered in the room, due to the design and new functional features thereof, so that all other lights can be eliminated and use can be limited to one single light. Said benefits are significant particularly in the increasing number of single-room apartments with single households, but also in the rooms of a multi-room residence.

The variety of applications possible with the automated variant of the device, useful for moving objects such as displays back and forth, represent an increase in living comfort, particularly for people who can no longer move about easily.

In addition to the benefit of saving costs for purchasing and operating lights and bulbs, the motion device provides new functions, producing a new aesthetic impression in conjunction with a corresponding product design that can increase residential comfort.

The automated variant of the device according to the invention for mounting an object on a room ceiling is independently significant. The motion device provides the potential for a series of advantageous, novel applications providing the user with new potential for improving living comfort, both as a positioning device for lights, but also further as a basic mechanical element, the motions thereof in three axes being able to be driven by motors and controlled electronically. The main features of the device and several examples of potential embodiments are listed here.

The device is made of a few simple components and functions.

a) A hollow profile 4 as a main element, preferably made of a lightweight plastic in an extrusion process, providing decorative color design potential on the outside surfaces thereof.

b) The hollow profile 4 can be rotated arbitrarily often in both directions about the center of rotation thereof, because a rotary bearing, preferably an axial ball bearing, a rotary electrical power transmission system, and an attachment device are combined into a unit at the center of rotation. Said central element is used to attach the entire device to the typical electrical connection and attachment point on the room ceiling. No additional attachment points are therefore required. It is also not necessary for this device to deviate from the typically central arrangement of the electrical connection and attachment point for new construction or renovations, thus reducing the cost of installing electrical lines. In rooms already equipped with ceiling lights, the device can be retrofitted in that the ceiling light is removed, the device installed at the same location, and the light then connected to the device. This would be the typical use of the motion device according to the invention.

c) Any arbitrary light for connecting to the motion device can be slide along the entire length of the hollow profile 4, so that the hollow profile 4 does not need to be rotated 180° in order to place the light at the exact opposite side of the center of rotation, as is the case in the prior art.

d) Depending on which side of the center point of the hollow profile 4 the light 2 is located, said half serves as a supporting arm and the other as a bracing arm.

e) Both ends of the hollow profile are supported against the ceiling by means of support rollers 20, so that the ends of the hollow profile 4 can “roll” on the room ceiling, wherein additional support roller springs 21 ensure that the rolls remain in contact with the room ceiling and ensure that the hollow profile 4 runs largely parallel to the ceiling, even if the ceiling is uneven, or tilting motions occur due to the continuous displacement of the weight from the shifting of the light.

f) Lights having a relatively large range of weights can be used, without the lever forces that occur requiring modifications (such as counterweights) to prevent deflection of the support element, or limitations (such as limiting the length of the support element) to the device. This is achieved by the support rollers 20 supporting the device against the room ceiling at all times and under all weight conditions and distributions.

g) The roller carriage 3 on which the light 2 is attached can reach all positions within a circular area inscribable on a typically square or rectangular room ceiling. The diameter of the circular area thereby corresponds to the length of the hollow profile 4.

h) The main element of the motion device, the hollow profile 4, can be decoratively designed at the outer surfaces thereof by applying adhesive films or by printing. Or, for example, interchangeable side covers 21 made of plastic, wood, metal, glass, or combinations thereof and variously decorated with colors can be used. Said covers can be inserted into guides formed into the hollow profile for this purpose. The user then has the potential to individually select colors and decor and to match the device and the light designs to each other. The user thus has an aesthetically pleasing unit consisting of the device and the light for serving as an independent stylistic element for living space design. This is interesting both to private users who retrofit the device according to the invention in a residence, and as a new lighting concept to interior architects who equip new residences with lighting.

i) Motorization and remote control of all executable mechanical motions are potential further embodiments, in that the axial bearing (clockwise and counterclockwise rotary motion), the roller carriage (left and right or forward and reverse horizontal motion), and the optional cable retractor (vertical motion up and down; not shown in the drawing) can be equipped with small electric motors (not shown in the drawing) supplied with electrical power by the main electrical connection and driven by a remote-controlled control unit (not shown in the drawing) present in the hollow profile 4. Each direction of motion is associated with a pushbutton on the remote control and the device is actuated in jog mode (moving when the button is pressed, stopping when the button is released.)

Additional functions can include:

1. Independent travel of the roller carriage to the stop at the end of the hollow profile when the corresponding button is pressed once.

2. Jog mode and travel to stop for the vertical cable retractor.

3. Jog mode and continuous mode for the rotary motion of the hollow profile 4, wherein the rotary motion continuous until the corresponding button is pressed again.

4. Speed controller for controlling the overall speed of all motions or each motion individually.

j) In the basic, mechanical, manually operated version of the device according to the invention, the light is displaced in the vertical direction in that a manually stoppable automatic cable wind-up device on the roller carriage 3 or, depending on the design, within the light cover, is actuated. Said devices function like automatic measuring tapes, automatic dog leashes, or self-locking and manually releasable cable wind-up devices on vacuum cleaners or hair dryers. For example, a light 2 having low weight can be suspended directly from the power cable of the same, and displaced up and down by hand in the vertical direction. In said standard version of the device according to the invention, the light is positioned in the vertical direction in that said light is pulled downward against the spring force of the automatic wind-up device and remains in said location when released, then is raised by the spring force again when pulled and released again. Or the locking can be done by hand using a locking knob.

In order to position the light in the horizontal direction, said light is pulled by hand along the hollow profile 4 to the desired position. In order to position the light on a circular path, said light is pulled transverse to the longitudinal axis of the hollow profile 4, wherein the light must be positioned outside of the center in this case, so that the hollow profile 4 can be rotated by pulling.

k)As a further embodiment of the electronic remote control, particular positions that have been reached can be programmed to programmable buttons on a remote control. To this end, positions that are often needed are traveled to and then saved. When the programmed button is pressed, the vertical cable first retracts completely for safety reasons. The roller carriage 3 then travels and the hollow profile 4 rotates at the same time, and both come to a stop with the programmed position has been reached.

Such positions can include:

Reading light at the head of a bed

Reading light above a sofa

Lighting above a dining table

Lighting above a desk

Lighting above the center of a seating arrangement

Background light for watching television

General lighting, etc.

The remote control can also include functions such as switching on and off or dimming the light. For the embodiment having an electronic remote control, the installation of a wall switch having said functions can be eliminated entirely. For new construction, the installation of electrical lines for light switches can be eliminated and costs for electrical installation can be saved. A holder for the remote control can take the place of the usual light switch.

l) A gesture controller is possible as a further embodiment of the electronic controller, wherein all of the above named motions and functions can be initiated by means of a sensor (such as Microsoft Kinect) through particular arm motions, and the light can thereby be “waved away or summoned.”

m)An “avoidance function” can be integrated as further embodiment of an electronic controller, achieved in that persons or objects in the immediate vicinity of the light are captured by means of a motion sensor mounted in the light or on the roller carriage, both when in motion and when standing still, and an avoidance motion is performed.

n) The electronic controller can potentially be a voice controller as a further embodiment. Similar to controlling the functions of a computer through spoken commands, electric motors installed on the device according to the invention and setting the light in motion are actuated by means thereof.

These can be commands in the form of verbal sounds, such as “Light on,” “Light off,” “Move closer”, “Stop,” “Move away,” “Dining table,” “Desk,” “Seating cluster,” “Darker,” “Lighter,” etc., or the command “Follow,” wherein the light automatically follows the person moving inside the room.

o) In a further embodiment of the device, it is possible to use the same as a power source and support for other electronic devices than lights, and other objects having low weight, such as lightweight televisions, DVD players, tablet PCs, laptops, photo and video cameras, etc. Said devices are then moved into and back out of position by means of the device, either mechanically by hand or by remote control for the electronic variants. For example, screen devices can be positioned at the desired distance from the seat of a person. Other objects for moving into place and away include books, medications, alarm clocks, etc. in corresponding mounting elements.

p) A further embodiment of the electrically controlled device us the use thereof for a variety of non-technical purposes, in that in place of the light, objects such as balls, ribbons, tires, etc. are suspended from the device and displaced within the room by means of electronically preprogrammed motion sequences. The user can bodily interact with said objects, for example by following a rising and falling ball by performing squats, and use the device in this manner as an exercise trainer. Training units of various lengths developed by exercise trainers can be saved to this end using a “teach-in” process, such as is used for painting robots, and various “exercise programs” can be saved in an electronic memory of the remote control. Said exercise programs can also be saved on external data storage media, such as USB sticks, and read in from the same. The user can then start the desired motion program from a selection menu on the remote controller.

q) As a further embodiment of the electronic controller, it is possible to program fantasy motions for the lights, initiated by programmed buttons, menu selections, or voice commands, such as “zigzag,” “spiral,” “twist,” “wave,” or “sun.” “Sun” means recreating the movement of the sun over the course of a day, wherein the light travels through an arc at an adjustable speed. The endpoints of the arc are at the bottom and the zenith is at the top. The light starts with a dimmed light at an endpoint toward the east (dawn), travels to the zenith as the light grows brighter (noon zenith), and then onward to the other endpoint in the west as the light fades.

Instead of one light, however, the support body can support a plurality of lights. Each light can be connected to a roller carriage in the interior of the hollow profile. The power supply to the roller carriage can be provided by means of cables. It is also possible, however, that busbars run within the hollow profile, from which the electrical power can be accessed by the roller carriage by means of sliding contacts. The lights can then be displaced along the support body separately from each other. Here again, the plurality of roller carriages can each be displaced independently of each other by means motors. This can also be done by means of the remote-controlled control unit.

An embodiment of the invention is described below in greater detail with reference to the enclosed drawings. In the drawings:

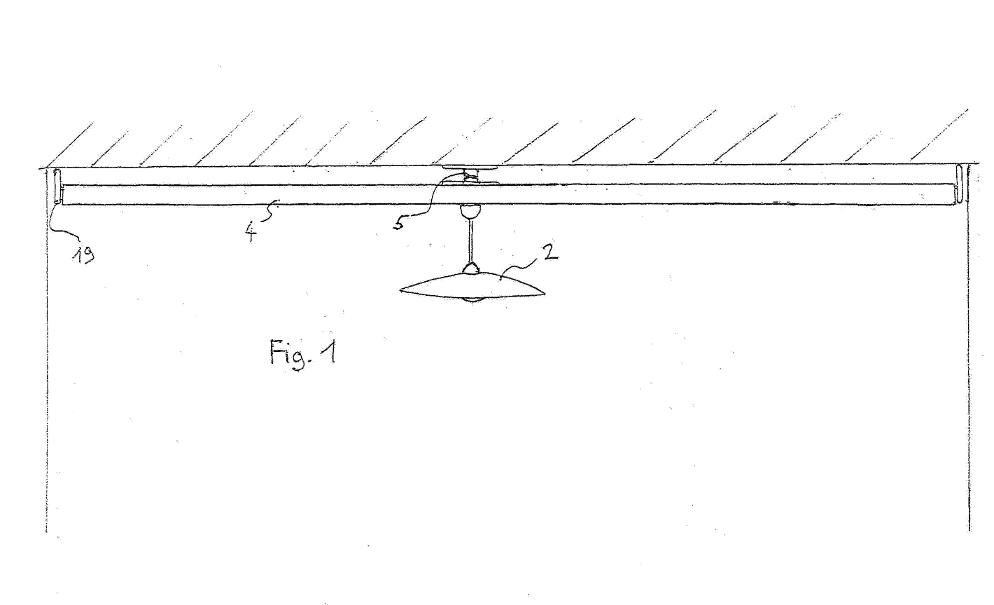

FIG. 1 A sketch of the side view of a motion device for ceiling lights according to the invention.

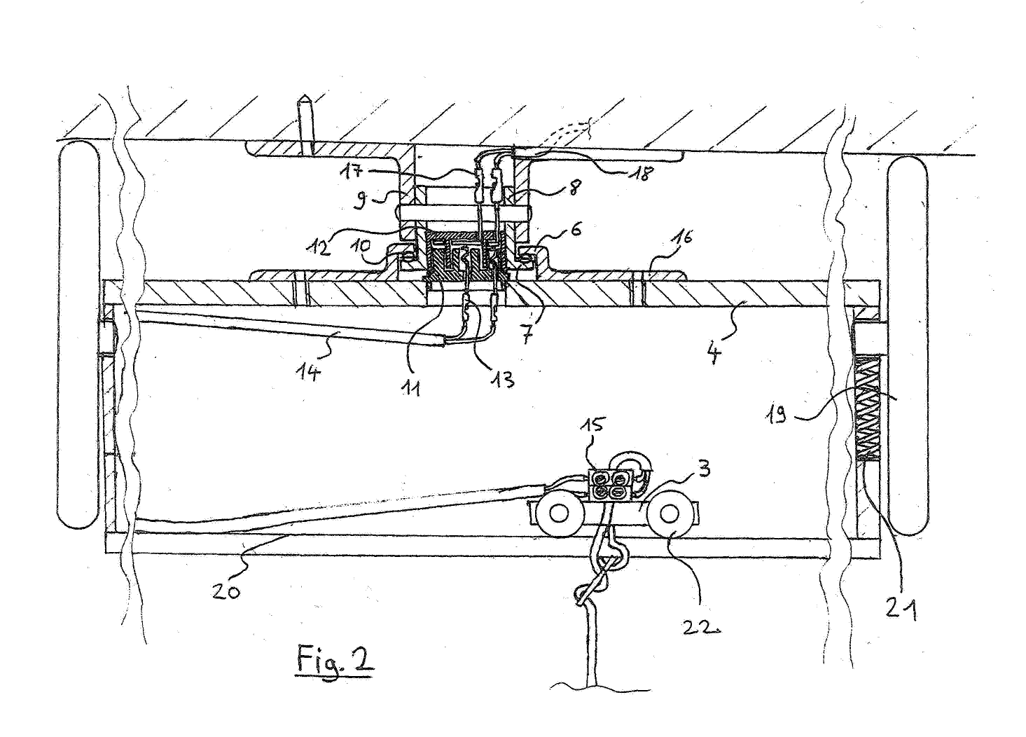

FIG. 2 A sketch of the longitudinal section view of a motion device for ceiling lights according to the invention.

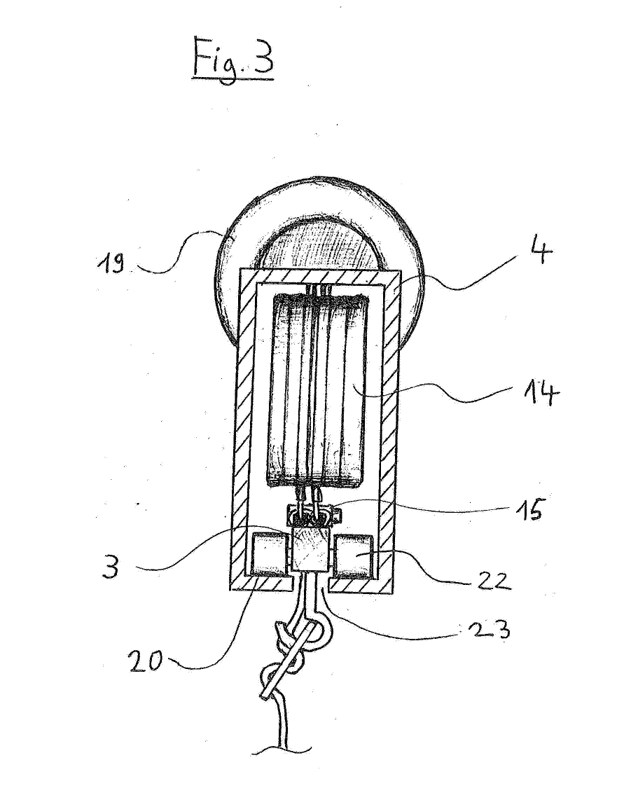

FIG. 3 A sketch of the cross section view of a motion device for ceiling lights according to the invention.

The benefits of the invention are achieved by the following construction of the device according to the invention, wherein here the non-motorized, manually operated basic embodiment is described.

The light 2 is attached to a roller carriage 3 displaceably placed in a hollow profile 4, on which hollow profile a current collector 11 is mounted, forming the bottom part of a power transmission system comprising the current collector 11 and power base 12, as is used in cordless water boilers able to rotate 360°. The use of a patented power transmission adapter (Strix Limited) designed for 230 V grid voltage is intended here.

The power transmission system is integrated in an axial bearing 5 mounted at the center of the hollow profile 4, comprising a top bearing washer 6, the hollow profile 4 being attached to the mounting tabs 16 thereof, a bottom bearing washer 7 having a tube 8 and attached to a ceiling mounting element 9 by means of the tube 8, and a ball bearing 10 present between the bottom bearing washer 7 and the top bearing washer 6. The axial ball bearing 10 is similar to those used in casters on shopping carts, for example. The current collector 11 is mounted on the top side of the hollow profile 4 by means of a center recess, such that the power connection points 13 thereof face into the hollow space of the hollow profile 4.

The power connection points 13 are connected to a power cable 14 routed in the hollow profile 4, laid loosely in the interior of the hollow profile 4 in a curved shape for the embodiment as a ribbon cable, or guided by a cable carrier placed in the hollow profile in a curved shape. The other end of the power cable 14 is connected to a cable connection element 15 attached to the roller carriage 3. The power cable 14 is dragged along when the roller carriage 3 is displaced, similar to a ribbon cable on the print head of an inkjet printer. The top bearing washer 6 comprises mounting tabs 16 to which the top side of the hollow profile 4 is attached.

The bottom bearing washer 7 comprises a tube 8 facing toward the room ceiling over the hole thereof, said tube being guided through the ball bearing 10 and the hole in the top bearing washer 6. The power base 12 is firmly inserted in the bottom end thereof, so that the power connection points 17 thereof face toward the room ceiling and are connected to stationary power cables 18 from the room ceiling. The current collector 11 is inserted into the power base 12 precisely when the hollow profile is attached to the mounting tabs 16 of the top bearing washer 6.

Support rollers 19 are mounted at both ends of the hollow profile 4, the axes of rotation thereof being disposed parallel to the longitudinal axis of the hollow profile 4, wherein the support rollers 19 protrude above the top edge of the hollow profile 4 in the direction toward the room ceiling, and continuously contact the room ceiling by means of a spring 21, even if the room ceiling is uneven and the distance between the room ceiling and the ends of the hollow profile thereby varies.

The support rollers 19 support the ends of the hollow profile 4 against the room ceiling in this manner during rotation, and thus ensure a stable, horizontal orientation of the hollow profile 4 while retaining full mobility, regardless of the position of the light 2 and the thereby changing lever forces. The entire device is attached to a corresponding ceiling mounting element 9 by means of the tube 8 of the bottom bearing washer 7, said mounting element in turn, depending on the design, being attached to the room ceiling in the immediate vicinity of the power connection point 17 by means of at least one screw.

The size, shape, design, selected material, and technical conception of the components listed above and claimed and described in the embodiment examples to be used according to the invention are not subject to any special exceptional conditions, so that the selection criteria known in the area of application can be used without limitation.

For the embodiment according to FIG. 1, the displacing device according to the invention is shown on which a typical suspended light 2 is mounted as an example, said light being present precisely in the center of the displacing device and thus in the center of the room ceiling, or precisely below the power connection point of the room ceiling. In said embodiment, the displacing device is operated by hand, that is, the bulb 2 is displaced by hand to the right or left to an arbitrary location on the hollow profile 4.

At the same time, the hollow profile can be rotated about the center axis thereof, in that the light 2 is pulled in a direction transverse to the hollow profile when the light 2 is present sufficiently far outside the center of the hollow profile 4. If the light 2 is present precisely in the center of the hollow profile 4, then the position of the light 2 remains unchanged when the hollow profile 4 is rotated. If the light 2 is pulled out of the center, then the position of the light 2 changes on a circular path when the hollow profile 4 is rotated. In this manner, the light 2 can be positioned at any arbitrary location within a circular area on the ceiling, wherein the length of the hollow profile 4 determines the diameter of the circular area.

FIG. 2 shows a longitudinal section showing the substantial internal and external components of the displacing device:

The power cable for the light 2 from FIG. 1 is connected to the cable connection element 15 on the roller carriage 3. The roller carriage 3 runs within the C-shaped hollow profile 4 on the running surfaces 20 for the roller carriage 3. The power cable for the light thereby always hangs through the slit 23 between the running surfaces 20 for the roller carriage 3. The cable connection element 15 on the roller carriage 3 is connected to a power cable 14, the other end of which is connected to a current collector 11 mounted in a recess centered in the hollow profile 4.

The power cable 14 in an embodiment as a ribbon cable is routed within the hollow profile 4 such that said cable is dragged along when the roller carriage 3 is displaced. The power cable 14 is long enough that the roller carriage 3 can be pulled or pushed to the two ends of the hollow profile 4. The power cable 14 is formed into a loop in the pushing direction and stretched out in the pulling direction. The rotating power transmission system comprises the current collector 11 mounted in a center recess on the top side of the hollow profile 4.

The current collector 11 engages in the counterpart thereof, the power socket 12, so that the electrical contacts of the current collector 11 and the power socket 12 contact each other. The power socket 12 is mounted in the bottom end of the tube 8 of the bottom bearing washer 7. The tube 8 of the bottom bearing washer 7 in turn is inserted into the tube of a ceiling mounting element 9, and said element in turn is attached to the ceiling. The power cable 18 on the ceiling either is present in the interior of the ceiling mounting element 9 or is fed into the mounting element from outside.

Support rollers 19 are mounted at both ends of the hollow profile 4, the axes of rotation thereof being disposed parallel to the longitudinal axis of the hollow profile 4, wherein the support rollers 19 protrude above the top edge of the hollow profile 4 in the direction toward the room ceiling, and are continuously pressed against the room ceiling by means of a spring 21.

FIG. 3 shows a cross-section of the hollow profile 4 of the displacing device, showing the location of the roller carriage 3 within the hollow profile 4:

The running rollers 22 of the roller carriage 3 rest on the interior running surfaces 20 of the C-shaped hollow profile 4, said running surfaces 20 flanking a slit 23 running along the entire length of the hollow profile 4. The power cable for the light 2 from FIG. 2 is guided by the slit 23 to the cable connection element 15. The bottom end of a power cable 14 in an embodiment as a ribbon cable is connected to the cable connection element 15 within the hollow profile 4. The connection of the upper end thereof to the current collector 11 from FIG. 2 is not shown. The location of the two support rollers 19 can also be seen in the view of FIG. 3.

The above embodiments serve to explain all of the inventions covered by the application and independently advancing the state of the art by the following combinations of features, namely:

A device characterized in that one support element 19 is provided at each of the two supporting arms and that the mounting element 3 can be displaced over the entire length of the support body 4.

A device characterized in that the support body 4 can be rotated through any arbitrary angle of rotation about the vertical axis without any limiting stop.

A device characterized in that the ceiling mounting element 9 comprises an axial bearing 5 having electrical contact means disposed coaxially to the vertical axis.

A device characterized in that the mounting element 3 is displaceable in a hollow of the support body 4 implemented as a hollow profile, particularly a C-profile, wherein it is particularly provided that the mounting element is a roller carriage 3 comprising running rollers 22 running on two running flanks flanking a slit extending in a direction of extent of the support body 4.

A device characterized in that the support elements are implemented as support rollers 19, each rotationally supported about an axis extending in the direction of extent of the support body 4.

A device characterized in that the support rollers 19 are each disposed at one end of the support body 4, wherein at least one, preferably both, of the support rollers 19 are spring-loaded in the vertical direction. A device characterized in that the consumer 2 is adjustable in the vertical direction.

A device characterized by drive motors driven by an electrical control device for rotating the support body 4 and/or for linearly displacing the mounting element 3 and/or for vertically displacing the object, particularly the consumer 2.

A device characterized in that the electrical control device is programmable, so that the object, particularly the consumer 2, can be controlled by a program for traveling along defined trajectories to various end positions.

### LIST OF REFERENCE NUMERALS

1 ———
2 Light
3 Roller carriage
4 Hollow profile
5 Attaching unit
6 (Top) bearing washer
7 (Bottom) bearing washer
8 Tube for bottom bearing washer
9 Ceiling mounting element
10 Axial ball bearing
11 Current collector
12 Power plug
13 Power connection point (current collector)
14 Power cord
15 Cable connector
16 Mounting tab
17 Power connection point (power socket)
18 Power cable (from ceiling)
19 Support roller of the hollow profile
20 Running surface for the roller carriage
21 Spring for supporting roller
22 Running roller for roller carriage
23 Slit

1. A device for mounting an object, particularly an electrical consumer (2), such as a light or a display having a ceiling mounting element (9) for attaching to a room ceiling, holding an elongated support body (4) extending in a horizontal plane and rotatable about the vertical axis running through the ceiling mounting element (9), and forming two support arms facing away from the ceiling mounting element, on which support body (4) a mounting element (3) displaceable in the direction of extent of the support body (4), on which an object, particularly the consumer (2) can be attached, the electrical supply line thereof running through the support body (4) to the ceiling mounting element, and a support element (19) for supporting the supporting body on the ceiling, characterized in that one support element (19) in the form of a support roller (19) is provided on each of the two supporting arms, said element being pivotally supported about an axis extending in the direction of extent of the support body (4), and that the mounting element (3) can be displaced along the entire length of the support body (4).

2. The device according to claim 1, characterized in that the support body (4) can be rotated about the vertical axis through an arbitrary angle of rotation without any limiting stop.

3. The device according to any one of the preceding claims, characterized in that the ceiling mounting element (9) comprises an axial bearing (5) having electrical contact means disposed coaxial to the vertical axis.

4. The device according to any one of the preceding claims, characterized in that the mounting element (3) can be displaced in a hollow of the support body (4) implemented as a hollow profile, particularly as a C-profile, wherein it is particularly provided that the mounting element is a roller carriage (3) comprising running rollers (22) running on two running flanks flanking a slit extending in the direction of extent of the support body (4).

5. The device according to any one of the preceding claims, characterized in that the support rollers (19) are each disposed at an end of the support body (4), wherein at least one, preferably all support rollers (19) are spring-loaded in the vertical direction.

6. The device according to any one of the preceding claims, characterized in that the consumer (2) can be adjusted in the vertical direction.

7. The device according to any one of the preceding claims, characterized by an drive motors actuated by an electrical control device for rotating the support body (4) and/or for linearly displacing the mounting element (3) and/or for vertically displacing the object, particularly the consumer (2).

8. The device according to claim 7, characterized in that the electrical control device is programmable, so that the object, particularly the consumer (2) can be displaced to various end positions along define displacement paths controlled by a program.

9. The device according to any one of the preceding claims, characterized in that two or more mounting elements (3) on each of which an object, particularly a consumer (2), can be mounted are displaceable in the direction of extent of the support body (4).
